(19) United States
(12) Patent Application Publication
(10) Pub. No.: US 2017/0114961 A1
(43) Pub. Date: Apr. 27, 2017

(54) VALVE UNIT FOR GAS CONTAINER WITH A PRESSURE-INDICATING OR AUTONOMY-INDICATION DEVICE NEAR THE TOP

(71) Applicant: L'Air Liquide, Société Anonyme pour l'Etude et l'Exploitation des Procédés Georges Claude, Paris (FR)

(72) Inventors: Emmanuel BAUNE, Saint Prix (FR); Damien GERMANI, PARIS (FR); Renaud LIGONESCHE, Herblay (FR); Philippe RUDNIANYN, Villiers sur Orge (FR); Chiara TRANTELLO, Puteaux (FR)

(21) Appl. No.: 15/125,298

(22) PCT Filed: Mar. 4, 2015
(86) PCT No.: PCT/FR2015/050525

§ 371 Date: Sep. 12, 2016

(30) Foreign Application Priority Data
Mar. 12, 2014 (FR) 1452041

(51) Int. Cl. F17C 13/04

(52) U.S. Cl. CPC F17C 13/04; F17C 2201/0104; F17C 2201/032; F17C 2201/058; F17C 2203/0639; F17C 2203/0646; F17C 2203/0648; F17C 2203/0663; F17C 2205/0165; F17C 2205/0188; F17C 2205/0308; F17C 2205/0338; F17C 2205/035; F17C 2205/0385; F17C 2205/0394; F17C 2221/011; F17C 2221/03; F17C 2223/0123; F17C 2223/036; F17C 2227/048; F17C 2250/043; F17C 2250/0491; F17C 2250/0626

(57) ABSTRACT

The invention relates to a gas distribution valve unit comprising a valve body (1) comprising a gas outlet orifice (6) via which the gas can leave the valve body (1), a first internal gas passage (3) fluidically connecting a gas inlet orifice (2) to the gas outlet orifice (13), a gas passage control system arranged on the first internal gas passage (3), and a control element (5) that a user can operate and that collaborates with the gas passage control system to control the passage of gas in the first internal gas passage (3), and a device (7) that indicates pressure or the gas autonomy. According to the invention, the valve body (1) comprises a second internal gas passage (11) fluidically connected to the first internal gas passage (3), and the pressure or autonomy indicating device (7) is fixed at the upper end (1a) of the valve unit, and comprises a pressure tapping (8) in fluidic communication with the second internal gas passage (11) so as to measure the pressure of the gas inside said second internal gas passage (11). Gas container equipped with such a valve unit.

The invention relates to a valve unit for distributing gas, with or without an integrated regulator system, which is intended to equip a gas container or the like and makes it possible to reduce the risk of errors in reading the pressure in particular, by virtue of greater flexibility regaIVRng the positioning of the elements subjected to high pressure, and to a gas distribution assembly comprising a gas cylinder, particularly a medical gas cylinder, and such a valve unit fixed to the gas cylinder and preferably with a protective cowling arranged around the valve unit in order to protect it from knocks and from dirt.

Industrial and medical gases are commonly packaged at high pressure in gas containers, typically gas cylinders, equipped with a valve unit, with or without integrated regulator, namely a simple valve of the open/closed type or a valve with an integrated regulator, also referred to as an integrated valve regulator or IVR, that allows the flow rate and pressure of the delivered gas to be controlled.

In order to protect this valve unit, it is common practice to arrange around said valve unit a protective cowling that forms a protective shell around the body of the valve. Such a cowling is commonly referred to as a “bonnet”. Cowlings of this type are notably described in documents EP-A-629812, DE-A-10057469, US-A-2004/020793 and EP-A-2586481.

Conventionally, the gases are packaged in the gas containers, typically gas cylinders, at high pressure, which means to say typically at pressures higher than 100 bar absolute, generally between 200 and 350 bar abs, or even higher.

The high-pressure gas leaving the container therefore has to be expanded before it can be used, which means to say that its pressure needs to be regulated down to a lower usage pressure, referred to as low pressure, for example a pressure lower than 20 bar abs, or even often lower than 10 bar abs.

The gas can be expanded either directly in the valve unit itself, when this is an integrated valve regulator unit, also referred to as an IVR unit, or downstream of the valve unit using a gas expansion device.

In all instances, in order to measure and control the pressure of the gas contained in the cylinder to which the valve unit is fixed, whether this unit be of the IVR unit type or not, use is generally made of a pressure indicating device, such as a pressure gage, the pressure tapping of which is in fluidic communication with the gas passage passing through the valve unit and carrying the high-pressure gas coming from the cylinder.

Given that the high-pressure gas enters the valve unit via its bottom part, which means to says its lower half, which is fixed to the container and which bears the gas inlet orifice of the valve unit, the pressure indicating device, typically a pressure gage, is also generally arranged at the bottom part of the valve unit, which means to say as close as possible to the high-pressure inlet into the valve body. This also meets technical requirements connected with the dimensions of the valve unit.

Similarly, it is also possible to resort to a gas autonomy indicating device to determine the usage time that corresponds to the quantity of gas remaining in the gas container equipped with the valve unit.

Now, the need for this gas pressure or autonomy indicating device to be positioned at the bottom part of the valve unit means that it is often difficult or awkward to read the gas autonomy or pressure value indicated by same, thereby leading to reading errors or the need for the user to adopt a certain position in relation to the cylinder in order to be able to correctly read the autonomy or pressure value given by the autonomy or pressure indicating device.

Document EP-A-2116332 itself teaches a portable device for supplying CO2 to a pneumatic tool. It comprises a gas cylinder equipped with a valve unit of the integrated valve regulator (IVR) type, protected by a protective cowling. The internal architecture of the IVR is conventional because it comprises a low-pressure internal chamber situated downstream of the site at which the gas is expanded, where a pressure tapping is taken. A pressure gage situated at the top of the IVR therefore makes it possible to know the pressure after expansion but not the pressure prior to expansion, namely the pressure of the high-pressure gas leaving the cylinder.

In the light of that, the problem that arises is that of making it more comfortable and/or easier to read the gas autonomy or pressure indicating device, preferably a pressure gage, with which a gas distribution valve unit, typically for a cylinder or another gas container, is equipped, while avoiding the aforementioned drawbacks, which means to say of proposing a valve unit of improved design.

The solution of the invention is therefore a gas distribution valve unit comprising:
a valve body comprising a lower part comprising a fixing system allowing the valve unit to be fixed to a gas container, and an upper part surmounting the lower part, the lower part of the valve body comprising a gas inlet orifice via which a gas can enter the valve body,
at least one gas outlet orifice via which the gas can reemerge from the valve body,
a first internal gas passage fluidically connecting the gas inlet orifice to the gas outlet orifice, and
a gas autonomy or pressure indicating device fixed to the valve body, such as a pressure gage,
characterized in that:
the valve body comprises a second internal gas passage fluidically connected to the first internal gas passage so that the gas pressure applied in said second internal gas passage is equal (i.e. strictly equal or approximately equal) to that applied in the first internal gas passage upstream of the site of fluidic connection of the first and second internal gas passages, and
the gas autonomy or pressure indicating device is fixed to the valve body at its upper end and comprises a pressure tapping in fluidic communication with the second internal gas passage so as to measure the pressure of the gas within said second internal gas passage, namely the pressure of the high-pressure gas present in the second internal gas passage.

In general, a valve unit accoIVRng to the present invention offers numerous advantages, aside from the comfort with which the user can read the pressure because of the possibility of positioning the autonomy or pressure indicating device at the top of the valve unit, it notably making it possible to provide one or more high-pressure gas outlets on top of the valve unit, which means to say on the opposite side of any expansion system present, from the gas source and also of improving the overall ergonomics of the valve unit, something which also has a tendency to reduce the risks of incorrect reading of a pressure in particular, thanks to increased flexibility in the positioning of the elements subjected to high pressure, namely the pressure indicating device, such as a pressure gage, or an autonomy indicating device, but also other elements such as pressure sensors, rupture disks, etc.

Depending on the scenario, the valve unit accoIVRng to the invention may comprise one or more of the following technical features:
it comprises a gas passage control system arranged on the first internal gas passage and a control member operable by a user and collaborating with the gas passage control system to control the passage of gas in the first internal gas passage, in the direction running from the gas inlet orifice to the gas outlet orifice, namely for adjusting the flow rate of the gas delivered.
the device indicating the content of the cylinder is a pressure indicator
the device indicating the content of the cylinder is a pressure gage.
the device indicating the content of the cylinder is a gas autonomy indicator.
the device indicating the content of the cylinder is a dial-type device or a digital device indicating an estimate of how long the gas corresponding to the quantity of gas remaining in the cylinder is expected to last.
the device indicating the content of the cylinder is preferably an electronic device which calculates and displays a gas autonomy expressed in time units.
the valve body comprises a gas expansion system arranged between the site of fluidic connection of the first and second internal gas passages and the gas outlet orifice. AccoIVRng to this embodiment, it is therefore an integrated valve regulator or IVR valve.
the axis BB of the pressure indicating device makes, with the axis AA of the valve body, an angle α comprised between 0 and 90°, preferably between 10° and 80°, more preferably between 25° and 70°.
the gas outlet orifice is borne by a gas outlet coupling situated between the upper and lower parts of the valve body for example.
the expansion system comprises a high-pressure chamber, a valve shutter and a valve seat, and a low-pressure chamber.
the system for controlling the passage of gas comprises a mobile element bearing calibrated orifices of increasing dimensions corresponding to increasing values of gas flow rate.
the mobile element of the system for controlling the passage of gas is a rotary disk. This rotary disk is pierced with calibrated orifices.
the rotary handwheel collaborates rotationally with the mobile element of the system for controlling the passage of gas so as to control the flow rate of gas delivered by the valve unit.
the portion of the first internal gas passage, situated between the gas inlet orifice and the site of fluid connection of the first and second internal gas passages, and the second internal gas passage are configured, which means to say able to and designed to, convey gas at high pressure.
the pressure indicating device is a dial-type pressure gage or a pressure gage with a digital display, also referred to as an “electronic” or “digital” pressure gage.
the pressure tapping of the gas autonomy or pressure indicating device is in fluidic communication with the second internal gas passage via a connecting passage formed in the body of the valve.
the control member operable by a user is a rotary handwheel or a pivoting lever, preferably a rotary handwheel.
the rotary handwheel is arranged coaxially and around the gas outlet connector bearing the gas outlet orifice.
the site of fluidic connection comprises the high-pressure chamber of the expansion system. This high-pressure chamber therefore has gas passing through it at high pressure, which means to say that the first passage of gas conveys the high-pressure gas as far as said high-pressure chamber and the second passage of gas discharges some of the high-pressure gas from said chamber and conveys it to the pressure tapping of the gas autonomy or pressure indicating device so that the pressure of said gas can be measured. In other words, the site of fluidic connection (i.e. the connection site) is situated upstream of the expansion system, and therefore of the expansion itself, the high-pressure chamber coinciding with the site of fluidic connection or being connected thereto.
the body of the valve is made of copper alloy, of brass, of steel or of stainless steel, or of aluminum alloy.
the fixing system that allows the lower part of the valve body to be fixed to a gas container comprises a screw thread formed on the external periphery of an enlargement of cylindrical or conical shape located in the region of the lower part of the valve body. The screw thread borne by the cylindrical or conical enlargement can be fixed by screw-fastening into a mating screw thread/tapped thread formed at the outlet orifice of the gas container, particularly on the neck of a gas cylinder.
the body of the valve further comprises a filling connection comprising a filling orifice, preferably with an internal nonreturn valve, allowing high-pressure gas to be introduced into the gas container equipped with said valve body, for example when it is empty, namely when it does not contain or no longer contains gas, or is near-empty, which means to say that it still contains a little gas.

The invention also relates to a gas distribution assembly comprising a gas container, such as a gas cylinder, and a valve unit fixed to said gas container, said valve unit being as indicated hereinabove.

Depending on the circumstance, the assembly of the invention may comprise one or more of the following technical features:
the gas container is a gas cylinder, also referred to as a carboy, a gas tank or a bottle.
a protective cowling is arranged around said valve unit, the protective cowling comprising an opening formed level with the upper part of the protective cowling and within which the pressure-indicating device, typically a pressure gage, or a gas autonomy indicating device, becomes housed, which means to say that the opening is formed through the wall of the cowling.
the protective cowling comprises a planar surface at its upper part, the opening comprising the gas autonomy or pressure indicating device being formed in said planar surface.
the planar surface forms a face that is oblique with respect to the vertical axis of the cowling.
the cowling is made of a polymer material, for example of plastic, or composite or of metal or metal alloy, for example steel, cast iron, aluminum or an aluminum alloy.
the cowling is made of plastic such as PVC, PE, PET, PP, PMMA, PU, PA, etc. It should be noted that the plastic may be filled or reinforced, which means to say may contain added fibers for example.
the protective cowling comprises a carry handle, preferably a carry handle connected to the cowling via one or more support uprights.
the carry handle is arranged on the cowling in such a way that the gas autonomy or pressure indicating device is positioned substantially between the carry handle and the valve unit bearing said gas autonomy or pressure indicating device.
the protective cowling further comprises a hang-up device, preferably a pivoting hang-up device, so that the assembly can be hung on a support, particularly the rung of a bed, to a stretcher, etc.
the carry handle and/or the support upright or uprights are formed from a rigid material selected from polymers and metals or metal alloys.
the carry handle is longiform overall. Typically, its length is comprised between 5 and 20 cm, preferably between 6 and 15 cm.
the carry handle surmounts the cowling body.
the carry handle is horizontal or near-horizontal and is perpendicular to the vertical axis of the cowling (i.e. the axis of the cowling corresponds to the axis of the valve and/or of the cylinder).
the gas cylinder has a size of between 10 and 150 cm.
the gas cylinder contains from 0.5 to 20 liters (water-equivalent capacity).
the gas cylinder has a hollow cylindrical body and comprises a neck bearing a gas outlet orifice to which the valve unit is fixed, preferably by screwing.
the gas cylinder contains a gas or gaseous mixture, preferably a gas or gaseous mixture that meets the specifications of the medical domain (pharmacopeia).
the gas cylinder contains a gas or gaseous mixture selected from oxygen, air, an N₂O/O₂ mixture, an He/O₂ mixture, an NO/nitrogen mixture or any other gas or gaseous mixture.
the cylinder is made of steel, of aluminum alloy, of composite material or a combination of several of these materials.
the cylinder contains gas at a pressure ranging up to around 350 bar.

The invention also relates to the use of a valve unit accoIVRng to the invention or of a gas distribution assembly accoIVRng to the invention to distribute a gas or gaseous mixture, preferably a medical gas or gaseous mixture.

For preference, the gas or the gaseous mixture is chosen from oxygen, air, N₂O/O₂, He/O₂, NO/nitrogen.

The invention will now be better understood from the following detailed description, given by way of nonlimiting illustration, with reference to the attached figures among which:

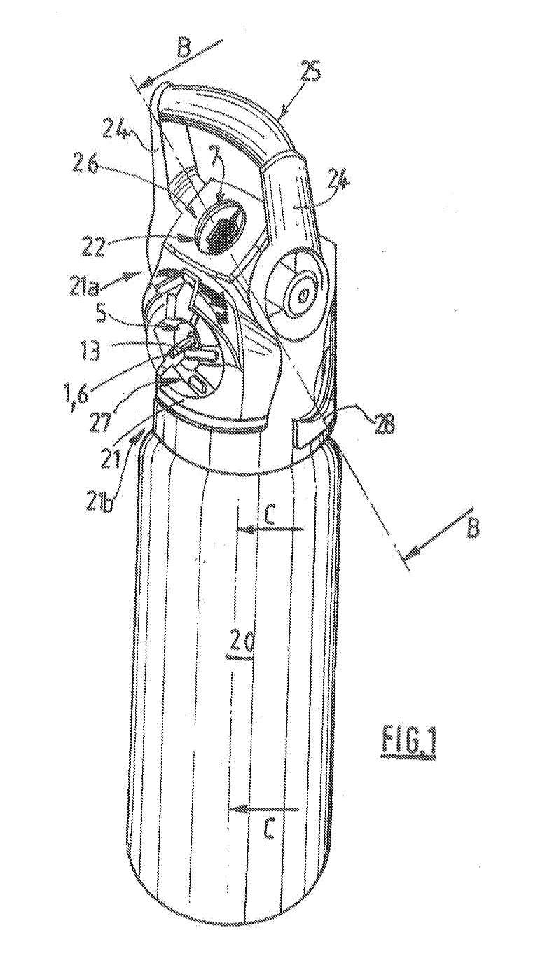

FIG. 1 depicts an embodiment of a cylinder/valve unit/cowling assembly accoIVRng to the invention, and

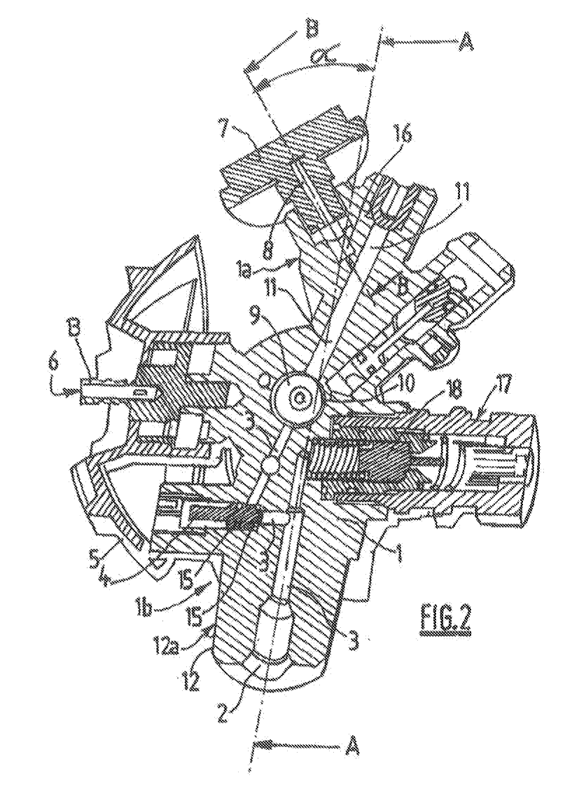

FIGS. 2 and 3 depict views in cross section of the valve unit accoIVRng to the invention of the assembly of FIG. 1,

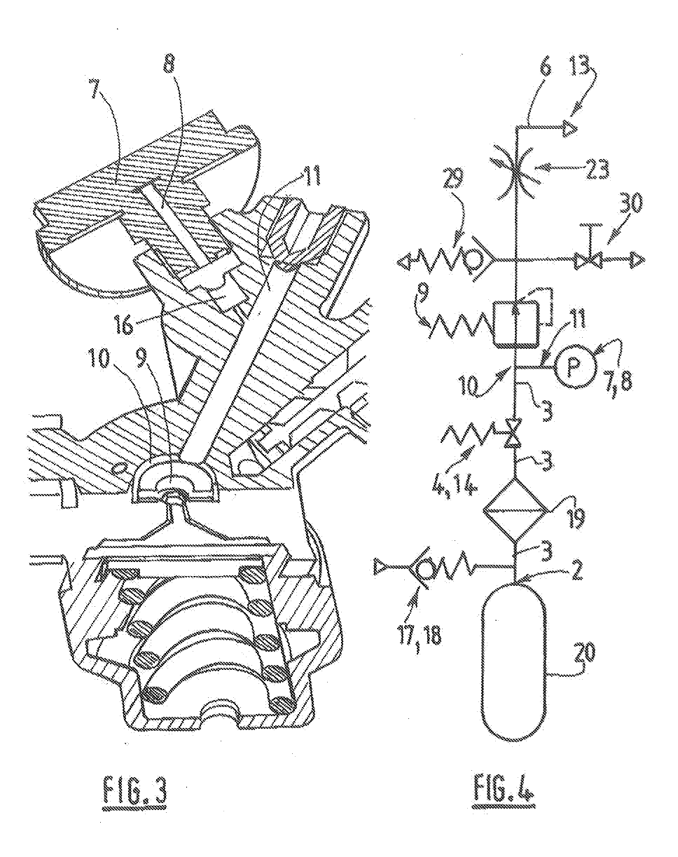

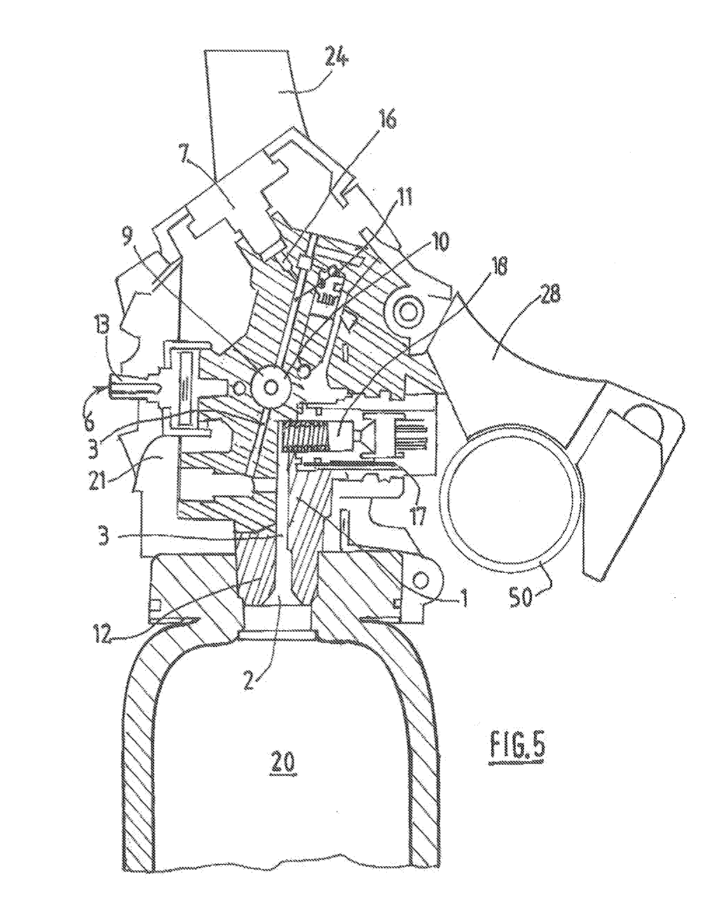

FIG. 4 schematically depicts the principle of operation of the valve unit accoIVRng to the invention of the assembly of FIG. 1, and

FIG. 5 depicts a view in cross section of the valve unit of FIG. 2 accoIVRng to the invention, arranged inside a protective cowling.

FIG. 1 shows one embodiment of a rigid protective cowling 21, also commonly referred to as a “bonnet”, arranged around a valve unit 1 accoIVRng to the invention (visible in FIG. 5), namely a valve unit that may or may not be an integrated valve regulator unit, itself fixed to the neck of a gas cylinder 20, said protective cowling 21 being provided with a carry handle 25 accoIVRng to the present invention.

The gas cylinder 20 typically has a cylindrical body made of steel and a size of between 10 and 150 cm, and a capacity of 0.5 to 20 liters (in water equivalent).

The protective cowling 21 allows the valve unit 1 to be protected against knocks whether the valve unit 1 is of the IVR type with integrated regulator or of the type without an integrated regulator.

Fixing around the valve unit 1 to the neck of the gas cylinder 20 is performed by screwing, using enlargement screw threads borne by the internal surface of the neck of the cylinder 20, on the one hand, and by the external surface of an enlargement 12 of substantially cylindrical or conical shape, situated at the base of the valve body 1 and bearing the gas inlet orifice 2, as visible in FIGS. 2 and 5, on the other.

More specifically, the protective cowling 1 comprises a cowling body 2 forming a protective shell around an internal volume sized to accept the valve unit 1, and a carry handle 25 designed to be held by a user in their hand.

The body of the cowling 21 is typically made of a material of the polymer and/or metal type, preferably from a plastic such as PVC, PE, PET, PP, PMMA, PU, PA, etc.

The carry handle 25 is made from a rigid material such as a polymer or a metal or a metal alloy and is borne by one or more support uprights 24 that mechanically connect the cowling body to the carry handle 25. The carry handle 25 is generally arranged horizontally, which means to say at right angles or near-right angles to the vertical axis of the cylinder 20 and of the cowling 21. The carry handle 25 has a longilinear shape, whether it be rectilinear or curved, typically a length shorter than 20 cm, typically from 6 to 15 cm.

One or more support uprights 24 are fixed to the carry handle 25 in such a way as to allow a user easily to carry the assembly comprising the bonnet 21, the valve 1 and the cylinder 20 using said carry handle 25.

The support uprights 24 may be formed from a plastic, like the body of the cowling 21, but may also be made of aluminum alloy or any other metallic material. They may be fixed to the handle 25 by screwing or welding, for example, or formed as one piece therewith.

The protective cowling 21 also has openings providing access to the valve unit 1 situated inside the internal volume of the cowling body.

In particular, a first opening 22 is created at the upper part 21a, also referred to as the top part, of the protective cowling 21, within which opening the pressure indicating device 7, namely in this instance a pressure gage, either of the dial type or of the electronic type, can become housed. The lower part 21b, also referred to as the bottom part, of the cowling 21 is positioned around at least part of the neck of the cylinder 20, as visible in FIG. 1.

More specifically, the protective cowling 21 comprises a planar surface 26 at its upper part 21a, namely at the top of the cowling, inside which the first opening 22 is created. The planar surface 26 in fact constitutes a face that is oblique with respect to the axis CC of the cylinder 20. For preference, the planar surface 26 is perpendicular to the axis BB of the pressure indicating device 7, as outlined in FIG. 1. Typically, the axes CC of the cylinder 20 and AA of the valve unit 1 are coincident, which means to say coaxial.

Furthermore, the protective cowling 21 comprises a second opening 27 formed on the façade or front face of the protective cowling, and in which the rotary handwheel 5 controlling the flow rate of gas passing through the valve unit 1 becomes housed, as explained hereinafter in conjunction with FIGS. 2 and 3.

In the embodiment of FIG. 1, the rotary handwheel 5 is arranged around the gas outlet connection 13 bearing the gas outlet orifice 6 used to withdraw the gas stored in the cylinder 20. However, the rotary handwheel 5 could be arranged differently, which means to say can potentially not be coaxial with the gas outlet connection 13.

Furthermore, the valve unit 1 also comprises a filling connection 17 with an internal check valve 18 (cf. FIGS. 2 and 5) which filling connection 17 is used to introduce pressurized gas into the cylinder 20 when the cylinder is empty or near-empty.

Furthermore, in order to allow the cylinder/valve unit/cowling assembly to be hung from or secured to a support, such as a bar of a hospital bed or stretcher, the protective cowling 21 comprises, on its rear face side, a pivoting hang-up device 28, able to pivot between a completely folded “rest” position (outlined in FIG. 1), which means to say the position adopted by the hang-up device 28 when stored in contact or near-contact with the body of the cowling 21, and a fully deployed position referred to as the “hang-up” position (not depicted), which means to say the position adopted by the hang-up device 28 when it is fully extracted and can be hung from a support, such as a bed rung or the like.

In all cases, the pressure indicating device 7 is fixed to the body 1 of the valve unit which is situated within the internal volume of the cowling 21, as visible in FIGS. 2 and 3. Arranging the pressure indicating device 7 in this way at the top on the valve unit 1 and on the façade of the cowling 21 makes it considerably easier to read the pressure delivered by the pressure indicating device 7, and avoids reading errors.

For preference, as illustrated in FIG. 2, the axis BB of the pressure gage 7 and the axis AA of the valve unit 1 form an angle α comprised between 0 and 90°, notably between 10° and 80°, preferably between 25° and 70°, and typically of the order of 35 to 55°.

As detailed in FIGS. 2 and 3, the gas distribution valve unit of the invention comprises a valve body 1 schematically comprising an upper part 1a forming the top of the valve unit 1, and a lower part 1b forming the base of the valve unit 1. The upper part 1a therefore surmounts the lower part or base 1b of the unit 1.

The lower part 1b of the valve unit 1 comprises the fixing system 12a, such as a screw thread, allowing the valve unit 1 to be fixed to the cylinder 20 as already explained, and the gas inlet orifice 2 via which a pressurized gas coming from the cylinder 20 can enter the valve body 1 and then be conveyed therein as far as the gas outlet orifice 6 borne by the outlet connection 13 via which the gas can re-emerge from the valve body 1.

As already explained, the lower part 1b of the valve body 1 is configured to be attached by screw fastening. For that, the lower part 1b comprises an enlargement 12 of the body projecting downwards, of cylindrical or conical overall shape and bearing a screw thread 12a on its external surface able to collaborate in screwing with a complementary screw thread or tapped thread formed in the neck of the cylinder 20.

A first internal gas passage 3 fluidically connects the gas inlet orifice 2 to the gas outlet orifice 6 borne by the outlet connection 13. This first internal gas passage 3 therefore passes axially through the enlargement 12 of the body 1 of cylindrical or conical overall shape, as shown in FIG. 1, said enlargement 12 also bearing the gas inlet orifice 2.

Moreover, the valve unit 1 also comprises a system 23 for controlling the passage or flow rate of gas collaborating with the control member 5, namely here a rotary handwheel operable by the user, to control the passage of gas in the first internal gas passage 3, which means to say to allow or, conversely, prevent, any circulation of the gas in said passage 3 in the direction running from the gas inlet orifice 2 to the gas outlet orifice 6 borne by the outlet connection 13.

The gas flow rate control system 23 comprises an element pierced with calibrated holes, the handwheel, as circumstances dictate, either causing the calibrated hole corresponding to the desired flow rate to collaborate with a fixed passage orifice or causing a mobile passage orifice to collaborate with the calibrated hole corresponding to the desired flow rate. Such an arrangement is commonplace and known to those skilled in the art.

Thus, accoIVRng to the embodiment depicted here, the element pierced with calibrated orifices is a mobile metal disk through which calibrated orifices pass. The orifices have different calibers, i.e. increasing calibers, each caliber corresponding to a given flow rate value. This disk is capable of rotational movement and is turned by the handwheel 5.

There are no valves in the passage control system accoIVRng to the embodiment set out in the figures. However, accoIVRng to other more conventional designs incorporating an opened/closed function in the high-pressure part of the valve unit, it is possible to provide for the handwheel 5 also to perform this open/close function. In this case, incorporating an opening/closing valve that seals onto a seat when closed, may prove to be necessary.

Furthermore, the valve unit also incorporates, as illustrated in FIG. 2, a translationally mobile valve shutter 4, one or more seals 15, such as o rings, and at least one return spring 14. The valve 4 is a residual-pressure valve intended to maintain constantly a positive pressure in the cylinder. This valve 4 operates autonomously, without action on the handwheel.

AccoIVRng to the present invention and as illustrated in FIGS. 2 and 5, the body 1 of the valve comprises a second internal gas passage 11 fluidically connected to the first internal gas passage 3 at a site of connection or fluidic connection 10.

The second internal gas passage 11 therefore forms a fork or branch off the first internal gas passage 3.

The second internal gas passage 11 and at least the portion of the first internal gas passage 3 comprised between the inlet orifice 2 and the fluidic junction site 10 carry gas at high pressure coming directly from the gas cylinder 20. These passages 11, 3 are therefore subjected to high pressure, typically to pressures ranging up to about 350 bar absolute.

Furthermore, the pressure indicating device, in this instance a pressure gage 7, which is fixed to the valve body 1 near the upper end 1a thereof, comprises a pressure tapping 8, for example a duct or the like, in fluidic communication with the second internal gas passage 11 so as to measure the gas pressure within said second internal gas passage 11.

The pressure tapping 8 of the pressure indicating device 7 may be fluidically connected to the second internal gas passage 11 indirectly, for example via a connecting passage 16 formed in the body 1 of the valve and connecting the pressure tapping 8 of the pressure indicating device 7 to the second internal gas passage 11, as illustrated in FIGS. 2, 3 and 5.

In the embodiment of FIGS. 2, 3 and 5, the valve unit is of the IVR type, namely comprises a regulator system 9 for expanding the gas which is positioned between the site of fluidic connection 10 of the first and second internal gas passages 3, 11 and the gas outlet orifice 6 so as to achieve a reduction in the pressure of the high-pressure gas coming from the cylinder 20 down to a lower pressure value, for example a passage from a high pressure above 100 bar to a low pressure below 20 bar abs.

To this end, in the conventional way, an expansion system 9 is provided that comprises an expansion valve shutter and a valve seat. The final pressure may be of adjustable or fixed value.

As visible in FIGS. 2, 3 and 5, the gas circulating along the second internal gas passage 11 is not subjected to expansion within the expansion system 9 because the site of connection or of fluidic connection 10 between the first and second gas passages 3, 11 is situated upstream of the expansion system 9.

The site of connection or of fluidic connection 10 is typically the chamber known as the high-pressure chamber of the expansion system 9, which high-pressure chamber then has passing through it the high-pressure gas which is conveyed to it by the first gas passage 3. Some of the high-pressure gas is then discharged via the second gas passage 11 which then carries it as far as the pressure tapping 8 of the pressure gage 7 (or of an autonomy measurement device) so as to allow the pressure of said gas to be measured. This design is of key importance to the context of the present invention.

FIG. 3 gives a better view of the expansion system 9 and the high-pressure chamber 10. More specifically, aside from the pressure tapping 8 and the pressure gage 7, it is also possible to see the expansion valve of elongate shape, i.e. with a stem, the valve seat, an expansion spring and an expansion piston which determines the position of the expansion valve accoIVRng to the load of the expansion spring, the high pressure and the low pressure.

All of these elements are also visible in FIG. 4 which outlines the principle of operation of the valve unit accoIVRng to the invention.

It is also possible to see there that the valve unit also comprises an internal filter 19 and, arranged downstream of the expansion system 9, a low-pressure gas outlet with isolation valve 30.

An assembly accoIVRng to the invention is particularly well suited for use in a medical environment, particularly for distributing any medical gas or gaseous mixture, particularly of the oxygen, air, N₂O/O₂, He/O₂, NO/nitrogen or some other type.

1. A gas distribution valve unit comprising:
a valve body (1) comprising a lower part (1b) comprising a fixing system (12, 12a) allowing the valve unit to be fixed to a gas container (20), and an upper part (1a) surmounting the lower part (1b), the lower part (1b) of the valve body (1) comprising a gas inlet orifice (2) via which a gas can enter the valve body (1),
a gas outlet orifice (6) via which the gas can reemerge from the valve body (1),
a first internal gas passage (3) fluidically connecting the gas inlet orifice (2) to the gas outlet orifice (13),
a gas autonomy or pressure indicating device (7) fixed to the valve body (1), wherein
the valve body (1) comprises a second internal gas passage (11) fluidically connected (10) to the first internal gas passage (3) so that the gas pressure applied in said second internal gas passage (11) is equal to that applied in the first internal gas passage (3) upstream of a site of fluidic connection (10) of the first and second internal gas passages (3, 11), and
the autonomy or pressure indicating device (7) is fixed to the valve body (1) at its upper end (1a) and comprises a pressure tapping (8) in fluidic communication with the second internal gas passage (11) so as to measure the pressure of the gas within said second internal gas passage (11).

2. The valve unit of claim 1 wherein the valve body (1) comprises a gas expansion system (9) arranged between the site of fluidic connection (10) of the first and second internal gas passages (3, 11) and the gas outlet orifice (6).

3. The valve unit of claim 1 wherein the pressure indicating device (7) is a dial pressure gage or a pressure gage with a digital display.

4. The valve unit of claim 1 wherein the autonomy indicating device (7) is a dial or digital device.

5. The valve unit of claim 1 wherein the autonomy indicating device (7) is an electronic device which calculates and displays a gas autonomy expressed in time units.

6. The valve unit of claim 1 wherein the valve unit comprises a gas flow rate control system (23) arranged on the first internal gas passage (3) and a control member (5) operable by a user and collaborating with the gas passage control system (23) to control the passage of gas in the first internal gas passage (3), in the direction running from the gas inlet orifice (2) to the gas outlet orifice (6).

7. The valve unit of claim 1 wherein the pressure tapping (8) of the gas autonomy or pressure indicating device (7) is in fluidic communication with the second internal gas passage (11) via a connecting passage (16) formed in the body of the valve (1).

8. The valve unit of claim 1 wherein an axis (BB) of the gas autonomy or pressure indicating device (7) forms, with an axis (AA) of the valve body (1), an angle (α) from 0° to 90°.

9. The valve unit of claim 2 wherein the site of fluidic connection (10) comprises a high-pressure chamber of the expansion system (9).

10. The valve unit of claim 1 wherein further comprising a control member (5) operable by a user, the control member comprising a rotary handwheel.

11. A gas distribution assembly comprising a gas container (20) and a valve unit (1) fixed to the gas container (20), wherein the valve unit (1) is in accordance with claim 1.

12. The gas distribution assembly as claimed in claim 11, wherein a protective cowling (21) is arranged around said valve unit (1), the protective cowling (21) comprising an opening (22) formed level with the upper part (21a) of the protective cowling (21) and within which the gas autonomy or pressure indicating device (7) becomes housed.

13. (canceled)

14. The gas distribution assembly of claim 11 wherein a gas or a gaseous mixture within the gas container (20) is chosen from oxygen, air, N₂O/O₂, He/O₂, NO/nitrogen.
